(19) United States
(12) Patent Application Publication
(10) Pub. No.: US 2026/0093596 A1
(43) Pub. Date: Apr. 2, 2026

(54) METRIC SUBSET SELECTION FOR DYNAMIC PERFORMANCE MONITORING

(71) Applicant: International Business Machines Corporation, Armonk, NY (US)

(72) Inventors: Akanksha Singal, New Delhi (IN); Kaustabha Ray, Bangalore (IN); Felix George, Kannur (IN); Mudit Verma, New Delhi (IN); Pratibha Moogi, Bangalore (IN)

(21) Appl. No.: 18/903,874

(22) Filed: Oct. 1, 2024

(51) Int. Cl. G06F 11/34

(52) U.S. Cl. CPC G06F 11/3447

(57) ABSTRACT

A method according to one approach includes: receiving observability metrics associated with a system, and quantifying the observability metrics by determining an entropy value associated with the respective observability metrics. The method further includes, comparing mutual information measures between pairs of the observability metrics in a subset of the observability metrics having respective entropy values that are in a first predetermined range. In response to determining differences between the mutual information measures of a given one of the pairs of the observability metrics are outside a second predetermined range, one of the observability metrics in the given pair is selected to maintain. Moreover, the remaining one of the observability metrics in the given pair is discarded.

### BACKGROUND

The present invention relates to data analysis, and more specifically, this invention relates to selecting specific subsets of metrics.

Data production continues to increase as computing power advances. For instance, the rise of smart enterprise endpoints has led to large amounts of data being generated at remote locations. Data production will only further increase with the growth of 5G networks and an increased number of connected mobile devices. Increased data production has also become more prevalent as the complexity of machine learning models increase. Increasingly complex machine learning models translate to more intense workloads and increased strain associated with applying the models to received data.

As data production increases, so does the overhead associated with processing the data. This is particularly true for metrics. For instance, the surge in the complexity of modern applications, especially those built on microservices architectures, has led to an increase in the volume of metrics that is produced. This data encompasses various streams, including logs, metrics, traces, etc. The influx of data is further amplified by the widespread adoption of cloud deployments, where observability becomes central to understanding the health and performance of these intricate systems.

### SUMMARY

A method according to one approach includes: receiving observability metrics associated with a system, and quantifying the observability metrics by determining an entropy value associated with the respective observability metrics. The method further includes, comparing mutual information measures between pairs of the observability metrics in a subset of the observability metrics having respective entropy values that are in a first predetermined range. In response to determining differences between the mutual information measures of a given one of the pairs of the observability metrics are outside a second predetermined range, one of the observability metrics in the given pair is selected to maintain. Moreover, the remaining one of the observability metrics in the given pair is discarded.

A computer program product, according to another approach, includes: one or more computer-readable storage media. The computer program product further includes program instructions that are stored on the one or more computer-readable storage media to perform the foregoing method.

A computer system, according to yet another approach, includes: a processor set, and one or more computer-readable storage media. The computer system also includes program instructions that are stored on the one or more computer-readable storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-operations for one of the operations in the method of FIG. 3A, in accordance with one approach.

FIG. 4A is a representational view of pseudocode, in accordance with an in-use example.

FIG. 4B is a representational view of pseudocode, in accordance with an in-use example.

FIGS. 4C-4G is a representational view of processing metrics using application topology information, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for performing topology-aware observability metric selection. In other words, approaches herein may be performed to desirably reduce the number of metrics that are evaluated by removing metrics that are not “rich” datapoints. The system as a whole is thereby able to operate more efficiently because metrics that provide the same or similar information about the performance of a system are not processed unnecessarily. Approaches herein thereby have a concrete impact on the achievable throughput of a compute system, e.g., as will be described in further detail below.

In one general approach, a method includes: receiving observability metrics associated with a system, and quantifying the observability metrics by determining an entropy value associated with the respective observability metrics. The method further includes, comparing mutual information measures between pairs of the observability metrics in a subset of the observability metrics having respective entropy values that are in a first predetermined range. In response to determining differences between the mutual information measures of a given one of the pairs of the observability metrics are outside a second predetermined range, one of the observability metrics in the given pair is selected to maintain. Moreover, the remaining one of the observability metrics in the given pair is discarded.

In another general approach, a computer program product includes: one or more computer-readable storage media. The computer program product further includes program instructions that are stored on the one or more computer-readable storage media to perform the foregoing method.

In yet another general approach, a computer system includes: a processor set, and one or more computer-readable storage media. The computer system also includes program instructions that are stored on the one or more computer-readable storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved metric selection code at block 150 for performing topology-aware observability metric selection. In other words, approaches herein may be performed to desirably reduce the number of metrics that are evaluated by removing metrics that are not “rich” datapoints. The system as a whole is thereby able to operate more efficiently because metrics that provide the same or similar information about the performance of a system are not processed unnecessarily. Approaches herein thereby have a concrete impact on the achievable throughput of a compute system, e.g., as will be described in further detail below.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

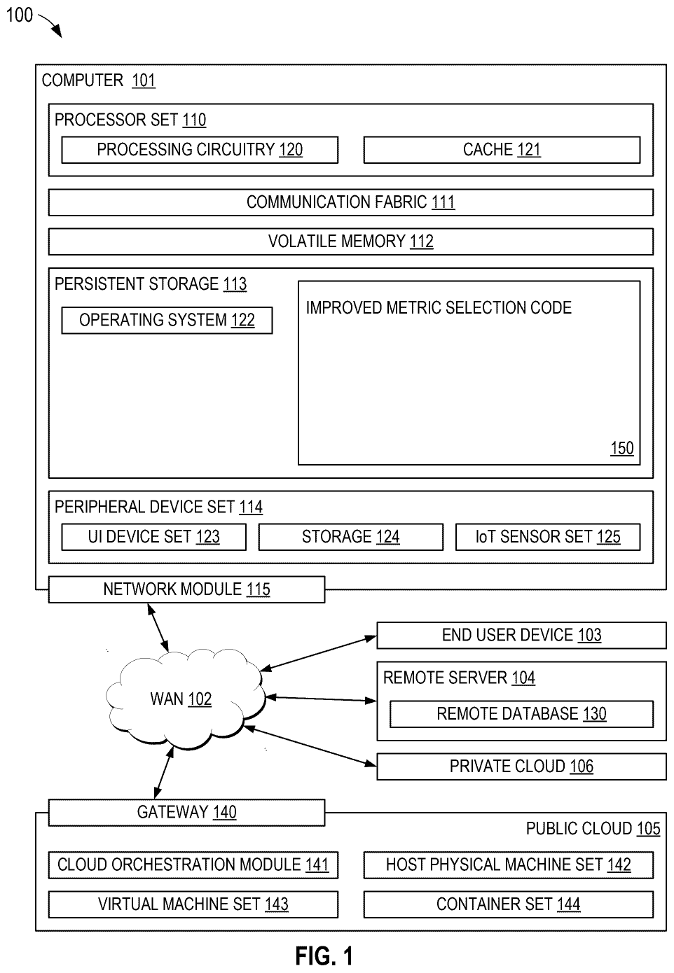

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144.

It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production continues to increase as computing power advances. For instance, the rise of smart enterprise endpoints has led to large amounts of data being generated at remote locations. Data production will only further increase with the growth of 5G networks and an increased number of connected mobile devices.

Increased data production has also become more prevalent as the complexity of machine learning models increase. Increasingly complex machine learning models translate to more intense workloads and increased strain associated with applying the models to received data.

As data production increases, so does the overhead associated with processing the data. This is particularly true for metrics. For instance, the surge in the complexity of modern applications, especially those built on microservices architectures, has led to a substantial increase in the volume of metrics that is produced. This data encompasses various streams, including logs, metrics, traces, etc. The influx of data is further amplified by the widespread adoption of cloud deployments, where observability becomes central to understanding the health and performance of these intricate systems.

Analyzing each and every metric is cumbersome, resource-intensive, and even impossible in some situations due to the sheer volume of data that is generated. This complexity can overwhelm traditional monitoring tools and methods, making it challenging to identify critical issues or performance bottlenecks. This is particularly true in systems that rely on real-time analysis. Even advanced analytical techniques, e.g., such as Artificial Intelligence for IT Operations (AIOps), driven automated anomaly detection, root cause analysis, failure and outage prediction, etc. are overwhelmed with large volumes and suffer from the “garbage in, garbage out” (GIGO) principle, producing poor quality outputs.

In sharp contrast to the foregoing shortcomings that are experienced by conventional products, approaches herein are desirably able to identify relevant subset of large sets of information. For instance, approaches herein are able to identify specific observability metrics from large sets that are most indicative of system health and status. In other words, approaches herein are able to identify relevant subsets of observability metrics that provide rich datapoints and remove remaining observability metrics from evaluation. This reduces the number of metrics that are evaluated by removing metrics that are not rich datapoints. Approaches herein thereby desirably identify which metrics are informative and which are not. Systems are able to operate more efficiently as a result, because metrics that provide the same or similar information about performance are not processed multiple times, e.g., as will be described in further detail below.

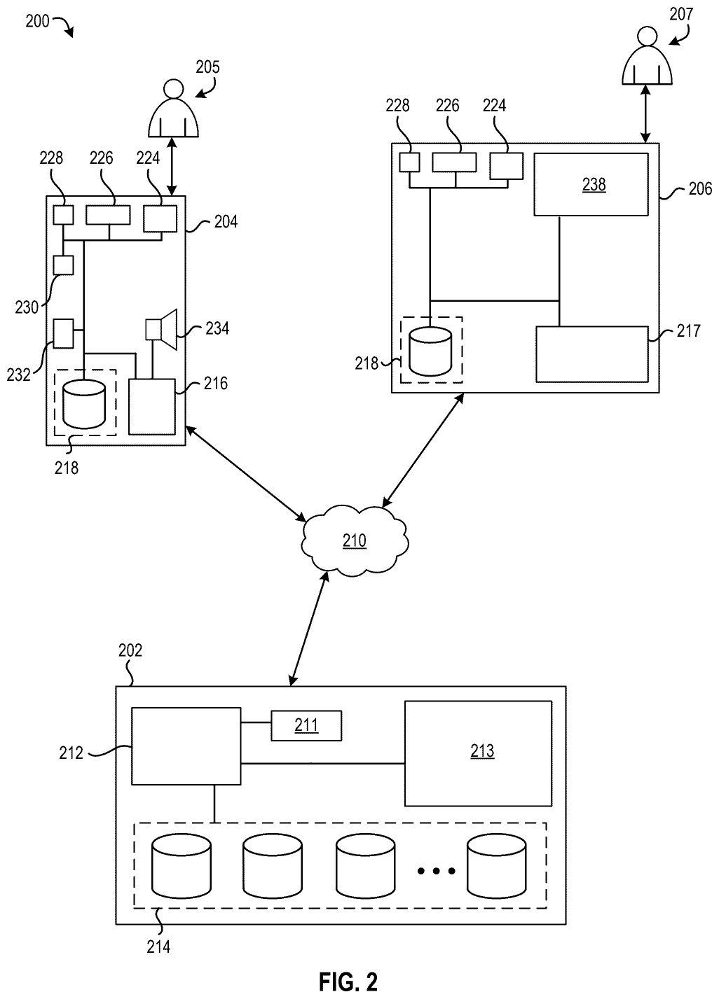

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The user device 204 and edge node 206 may thereby be considered “endpoint devices,” each of which are connected to the central server 202. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

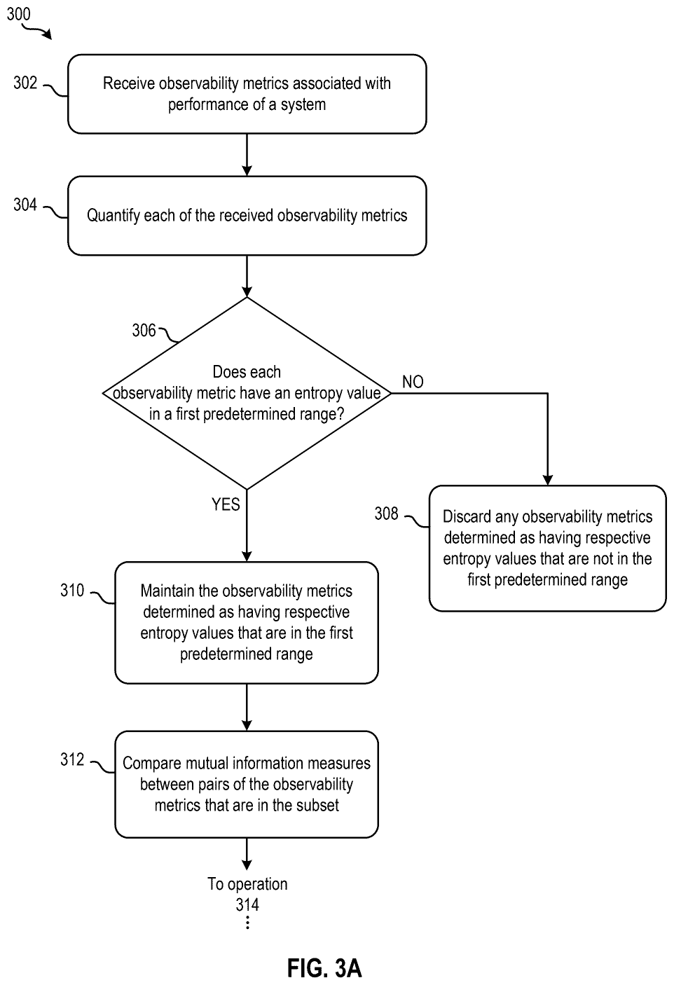

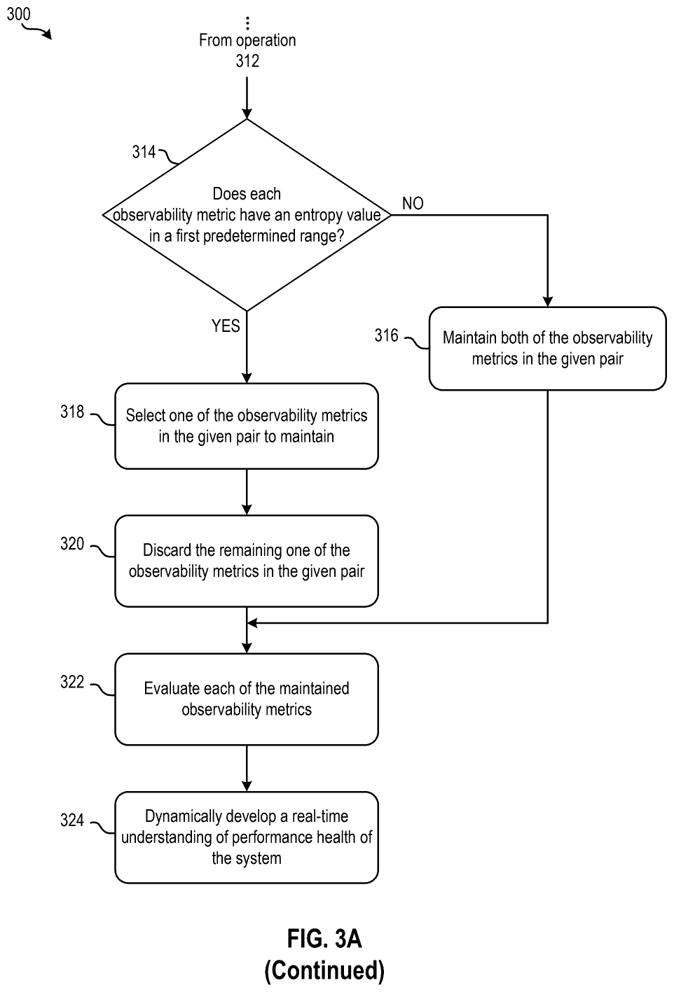

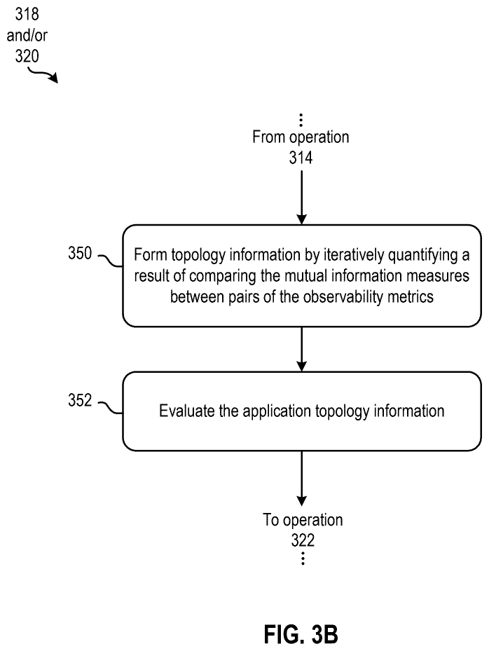

The central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 includes models that are trained to evaluate new observability metrics and identify rich datapoints therein (e.g., by identifying one or more patterns in the observability metrics). The AI based models may further be incrementally re-trained as observability metrics are received and evaluated over time, thereby providing a dynamic ability to evaluate performance information in real-time and provide an accurate assessment thereof while also maintaining desirable compute throughput. As noted above, this has previously been unachievable due to the intense compute workloads associated with conventional product performance. It follows that AI module 213 and/or processor 212 may be used to perform one or more of the operations in method 300 of FIG. 3A, e.g., as will be described in further detail below.

With continued reference to FIG. 2, the terms “user” and “administrator” are in no way intended to be limiting either. For instance, while users and administrators may be described as being individuals in various implementations herein, a user and/or an administrator may be an application, an organization, a preset process, etc. The use of “data,” “datapoints,” and “information” herein are in no way intended to be limiting either, and may include any desired type of details, e.g., depending on the type of operating system implemented on the user device 204, edge node 206, and/or central server 202. In some approaches, sets of performance based observability metrics may be generated at the edge node 206 and kept at the edge node 206 for evaluation and processing. However, compute threshold may be somewhat limited at the edge node 206 (e.g., at least in comparison to the threshold of central server 202), making any unnecessary overhead have a significant impact on performance overall. Thus, by evaluating observability metrics and choosing to only maintain and/or evaluate rich datapoints, approaches herein are desirably able to significantly reduce compute overhead. It should also be noted that the type of observability metrics received may differ. For instance, in preferred approaches the observability metrics include timeseries data outlining (e.g., associated with) performance health of the system. However, any desired type of observability metrics may be received.

User device 204 further includes a processor 216 which is coupled to memory 218. The processor 216 receives inputs from and interfaces with user 205. For instance, the user 205 may input information and/or queries using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Requests may be received at the edge node 206 and/or central server 202 from user device 204. For instance, performance data (e.g., observability metrics), requests, instructions, commands, etc., may be received from one or more applications that are running at user device 204 and/or edge node for evaluation using AI module 213 at central server 202. These may be received as a result of applications, and the microservices included therein, running and interacting with each other. As a result, AI based models at the central server 202 may be developed and trained to efficiently evaluate the received observability metrics and other performance based information to identify rich datapoints therein. Again, choosing to only maintain and/or evaluate rich datapoints allows approaches herein to significantly reduce compute overhead involved with analyzing performance, much less in real-time, e.g., as will be described in further detail below.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include models that are trained to evaluate new observability metrics and identify rich datapoints therein (e.g., by identifying one or more patterns in the observability metrics). The AI based models may further be incrementally re-trained as observability metrics are received and evaluated over time, thereby providing a dynamic ability to evaluate performance information in real-time and provide an accurate assessment thereof while also maintaining desirable compute throughput. As noted above, this has previously been unachievable due to the intense compute workloads associated with conventional product performance. It follows that AI module 238 and/or controller 217 may be used to perform one or more of the operations in method 300 of FIG. 3A, e.g., as will be described in further detail below.

Looking now to FIG. 3A, a flowchart of a computer-implemented method 300 for performing topology-aware observability metric selection, is illustrated in accordance with one approach. In other words, method 300 may be performed to desirably reduce the number of metrics that are evaluated by removing metrics that are not “rich” datapoints. The system as a whole is thereby able to operate more efficiently because metrics that provide the same or similar information about the performance of a system are not processed unnecessarily. Approaches herein thereby have a concrete impact on the achievable throughput of a compute system.

Method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions. Each of the steps of the method 300 may be performed by any suitable component of the operating environment using known techniques and/or techniques that would become readily apparent to one skilled in the art upon reading the present disclosure. For example, one or more processors located at a central server of a distributed system (e.g., see processor 212 of FIG. 2 above) may be used to perform one or more of the operations in method 300. In another example, one or more processors are located at an edge server (e.g., see controller 217 of FIG. 2 above).

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving observability metrics associated with performance of a system. In other words, information associated with (e.g., outlining) the performance of one or more applications and/or microservices thereof that are running in a system is received. The type, format, and/or amount of observability metrics received in operation 302 may vary depending on the implementation. As noted above, observability metrics are produced by a number of different applications, microservices, programs, etc., that may be running on a given system. For instance, in preferred approaches the observability metrics include timeseries data outlining (e.g., associated with) performance health of the system. However, any desired type of observability metrics may be received. Moreover, performance data may be received from physical and/or logical components that are used to run the applications, microservices, programs, etc.

In some approaches, additional information may also be received and used during the process of evaluating the received observability metrics. For instance, background information corresponding to the observability metrics is received. In other words, details that describe certain characteristics of the observability metrics may also be received. According to another example, which again is in no way intended to limit the invention, a collection plan that includes details describing how the received observability metrics were generated may be obtained. In other words, information in the collection plan may outline performance objectives, operating settings, experienced errors, data collection methods, participants, etc., or any other relevant information about the observability metrics. This background information thereby provides useful insight into the received observability metrics and can be used to gain a better understanding of which portions of the observability metrics serve as rich datapoints.

Typically, a significant amount of performance related information is received. As noted above, conventional products are overwhelmed attempting to process the sheer amount of performance information that is produced therein. In sharp contrast, approaches herein are able to identify specific observability metrics from large sets that are most indicative of system health and status. In other words, approaches herein are able to identify relevant subsets of observability metrics that provide rich datapoints, and selectively remove remaining observability metrics from being evaluated. This reduces compute overhead significantly by removing metrics that are not rich datapoints. Systems are able to operate more efficiently as a result, because metrics that provide the same or similar information about performance are not processed multiple times, e.g., as will be described in further detail below.

From operation 302, method 300 advances to operation 304. There, operation 304 includes quantifying each of the received observability metrics. In preferred approaches, the observability metrics are quantified by determining an entropy value (e.g., measure) for each of the respective observability metrics. Analyzing the entropy of each observability metric determines the amount of information each metric provides about the overall health and state of the system. As used herein “entropy” measures the uncertainty or unpredictability of a time series observability metric. It follows that metrics with higher entropy contain more information and serve as rich datapoints, as they capture a wider range of system behaviors and anomalies that are useful in determining real-time performance of the system. Other details and patterns may be identified in the observability metrics for further evaluation in selecting observability metrics that are actually evaluated, e.g., such as seasonality, variation, skew, temperature, etc. Thus, by retaining only the rich metrics that provide more valuable information, approaches herein are able to focus compute throughput on the most informative (e.g., rich) data, thereby reducing the complexity and volume of metrics to be monitored.

Entropy may thereby quantify the amount of uncertainty or randomness in a data source. Entropy may also be expressed as the number of bits associated with representing the uncertainty in the data, providing a fundamental metric for assessing the variability and unpredictability within a set of observations. According to one approach, which is in no way intended to limit the invention, the entropy “H” may be calculated for a given observability metric using the following equation:

$$H = - {\sum }_{i = 1}^{n} {p}_{i} log ( {p}_{i} )$$

Here, pᵢ represents the probability represents the probability distribution drawn on a given metric space “m” for all values of “i” between 1 and “n”. However, it should be noted that entropy may be calculated for the observability metrics using any desired processes.

Referring still to FIG. 3A, method 300 advances from operation 304 to operation 306 in response to quantifying each of the received observability metrics. There, operation 306 includes determining whether each observability metric has an entropy value that is in a first predetermined range. In other words, operation 306 includes determining whether each of the observability metrics contain a sufficient amount of information that they should be further evaluated. The predetermined range may be set by a user, predefined for one or more applications and/or microservices, set according to industry standards, dynamically adjusted based on past performance (e.g., previous iterations of performing the operations in method 300), etc.

In response to determining a given one of the received observability metrics has an entropy value that is not in a first predetermined range, method 300 advances to operation 308. There, operation 308 includes discarding any observability metrics determined as having respective entropy values that are not in the first predetermined range. In other words, any observability metrics identified in operation 306 as not having a high enough entropy value and/or not providing sufficient insight into performance of the system are discarded from evaluation and ignored. Again, this reduces the overall compute overhead that is associated with monitoring performance, thereby allowing for approaches herein to maintain an accurate understanding of how various applications and/or microservices therein are performing in real-time, which has been conventionally unachievable.

However, returning to operation 306, method 300 advances to operation 310 in response to determining that a given one of the received observability metrics has an entropy value that is in the first predetermined range. There, operation 310 includes maintaining the observability metrics determined as having respective entropy values that are in the first predetermined range. It follows that operation 306 and others in method 300 may be performed for each observability metric received in operation 302. Method 300 may thereby repeat any one or more of the operations therein in an iterative fashion for each of the received observability metrics.

While observability metrics determined as having desirable entropy values may be identified as providing desirable performance insight, additional evaluations may be performed on this subset of the observability metrics to determine which ones are ultimately processed. For instance, a subset of the observability metrics determined in operation 306 as having respective entropy values that are in a first predetermined range, and maintained in operation 310, are processed in operation 312. There, operation 312 includes comparing mutual information measures between pairs of the observability metrics that are in the subset. In other words, operation 312 includes quantifying the relationship between the observability metrics using calculations of mutual information. As used herein, “mutual information measures” provide a quantitative measure of the amount of information a given observability metric contains about another observability metric.

Mutual information measures are thereby used to assess the degree of dependency between given variables, revealing significant insights into relationships and interactions between the variables. Approaches herein are desirably able to leverage mutual information measures in order to determine how much the uncertainty of one metric is reduced by knowing (e.g., determining) the value of another metric. This allows the approaches to identify the most informative and relevant ones of the observability metrics for system monitoring.

According to one approach, which is in no way intended to limit the invention, the mutual information measures may be calculated for a given pair of observability metrics using the following equation:

$$I ( {m}_{1} , {m}_{2} ) = {\sum }_{x ∈ {m}_{1}} {\sum }_{y ∈ {m}_{2}} p ( x , y ) log ( \frac{p ( x , y )}{p ( x ) p ( y )} )$$

Here, I(m₁; m₂) represents the mutual information measures for observability metrics “m₁” and “m₂”, while p(x, y) represents joint probability for the indicated values of “x” and “y”. However, it should be noted that mutual information measures may be calculated for the observability metrics in a given pair using any desired processes which would be apparent to one skilled in the art after reading the present description.

With continued reference to FIG. 3A, method 300 advances from operation 312 to operation 314. There, operation 314 includes determining whether differences between the mutual information measures of each pair of remaining observability metrics are outside a second predetermined range. In other words, operation 314 includes determining whether the differences between each pair of the remaining observability metrics are sufficient that both should be maintained. Accordingly, method 300 advances from operation 314 to operation 316 in response to determining that the mutual information measures for a given pair of observability metrics is not outside the second predetermined range. This provides insight that the observability metrics in the given pair are sufficiently different that they each provide rich datapoints that are different from each other. Accordingly, operation 316 includes maintaining both of the observability metrics in the given pair.

However, returning to operation 314, method 300 advances to operation 318 in response to determining that the differences between the mutual information measures in a given pair of the observability metrics are outside the second predetermined range. In other words, method 300 advances to operation 318 in response to determining that the given pair of observability metrics at least partially overlap, providing the same performance based information about the system. There, operation 318 includes selecting one of the observability metrics in the given pair to maintain, while operation 320 includes discarding the remaining one of the observability metrics in the given pair. It follows that operations 318 and 320 involve choosing one of the overlapping observability metrics to maintain for processing, while the other observability metric is ignored and does not increase compute overhead.

Referring now momentarily to FIG. 3B, exemplary sub-operations of selecting one of the observability metrics in a given pair to maintain, and discarding the remaining one of the observability metrics in the pair, are illustrated in accordance with one approach. It follows that one or more of these sub-operations may be used to perform operations 318 and/or 320 of FIG. 3A. However, it should be noted that the sub-operations of FIG. 3B are illustrated in accordance with one approach which is in no way intended to be limiting.

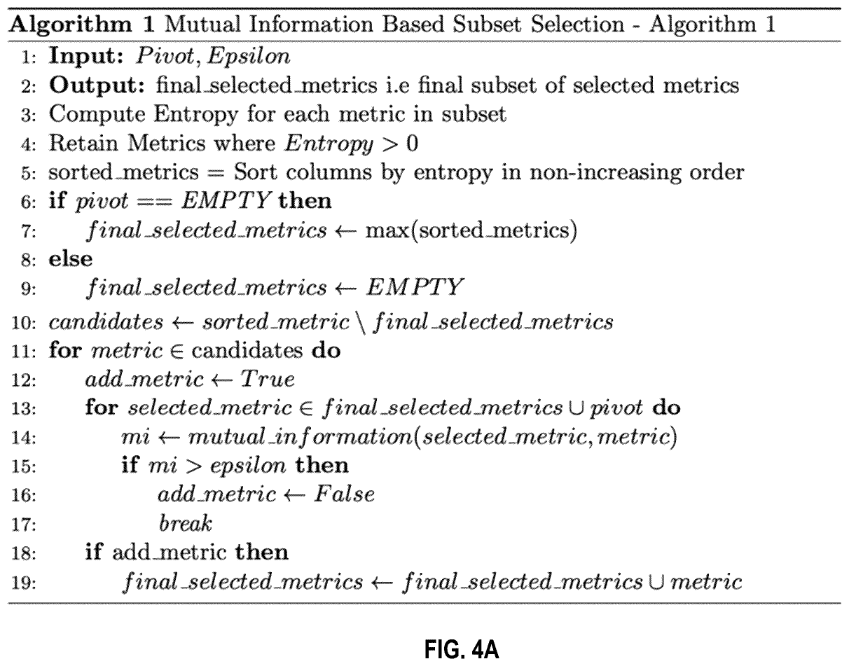

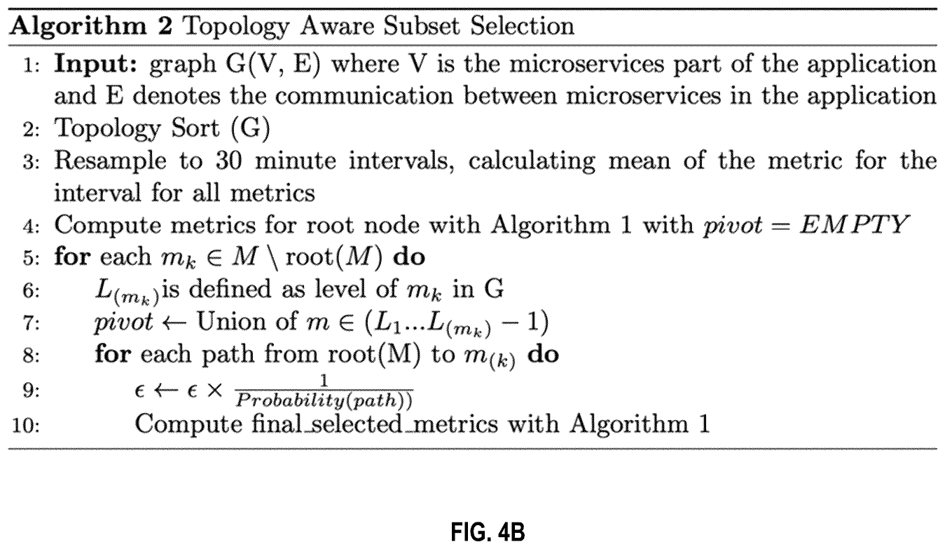

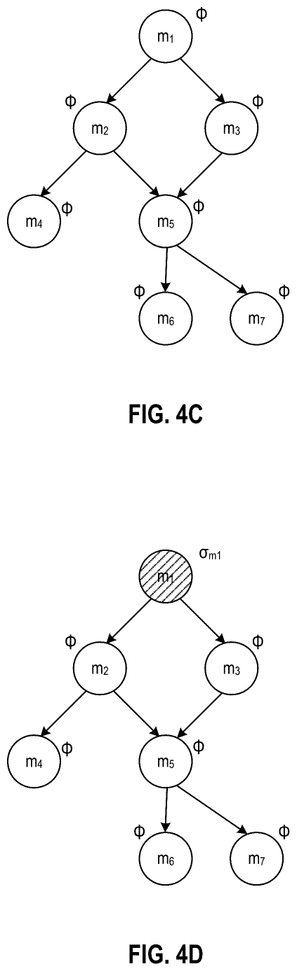

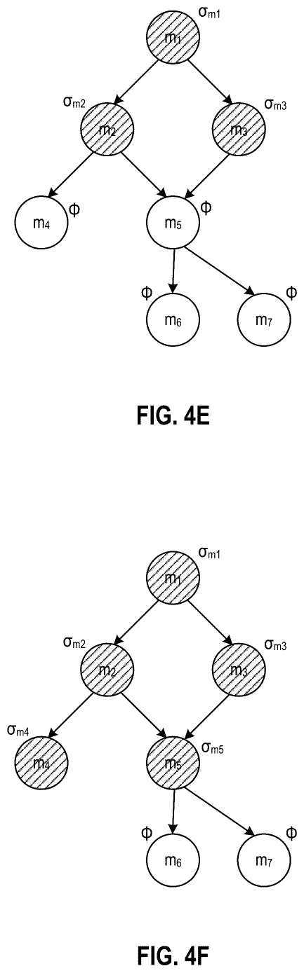

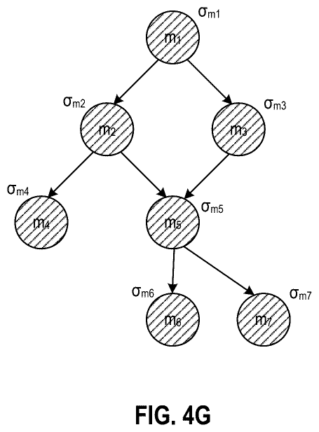

As shown, sub-operation 350 includes forming topology information by iteratively quantifying a result of comparing the mutual information measures between pairs of the observability metrics. In other words, the mutual information measures of pairs of observability metrics are combined to form topology information. This topology information may be represented in a graphical structure in some approaches (e.g., see FIGS. 4A-4G below).

Moreover, sub-operation 352 includes evaluating the application topology information. In other words, sub-operation 352 includes using the application topology information to augment the process of selecting one or more of the observability metrics to maintain, and one or more of the observability metrics that are discarded (e.g., not processed). In preferred approaches, the process of selecting the observability metric(s) to maintain includes conditioning the selection on probabilities that respective paths in the topology information are executed while accounting for dynamic behavior.

Microservice architecture involves services which perform specific tasks and are deployed as separate entities. Moreover, data flows from one service to another along specific channels. Application topology may thereby be used to form a specific directed acyclic graph G (V, E), where “V” represents the microservices part of an application, and “E” denotes the communication between microservices in the application. It follows that path probabilities in the resulting graph “G” may be utilized (e.g., referenced) while selecting metrics that should be maintained for processing for each microservice represented therein, e.g., as would be appreciated by one skilled in the art after reading the present description.

Returning now to FIG. 3A, method 300 advances from operation 320 to operation 322. There, operation 322 includes evaluating each of the maintained observability metrics. In other words, operation 322 includes processing each of the observability metrics that remain from what was received in operation 302. Method 300 is also shown as advancing from operation 316 to operation 322. Operation 322 may thereby include evaluating all of the observability metrics identified as rich datapoints. It follows that operations in method 300 may be repeated in an iterative fashion for each of the observability metrics that are originally received. For example, operations 314, 316, 318, and/or 320 may be repeated in an iterative fashion for each pair of observability metrics identified as having desirable entropy.

Method 300 further advances from operation 322 to operation 324. There, operation 324 includes dynamically developing a real-time understanding of performance health of the system. In other words, the maintained (e.g., remaining) observability metrics are used to perform a dynamic system health check. This dynamic system health check can be performed in real-time as a result of significant reductions to the compute overhead that is consumed during the evaluation. Again, by removing metrics (e.g., samples) that are not “rich” datapoints, the compute overhead associated with maintaining a real-time understanding of how a system is performing is significantly reduced. This allows for compute throughput to be directed to incoming requests and running applications, thereby significantly increasing throughput of the system as a whole. It should also be noted that “rich” metrics refer to sets of performance information that are of high quality and provide sufficient insight to gain an accurate picture or understanding of how the system is actually performing. In contrast, metrics that are not rich include performance information that does not provide valuable or novel insight to how a system is performing.

It follows that operations in method 300 are desirably able to reduce the metric space associated with dynamic monitoring of system performance, thereby greatly reducing the compute overhead consumed by performing performance based alert recommendations, volume management, overall manageability for users (e.g., such as Site Reliability Engineers (SREs)). As noted above, approaches herein are desirably able to identify relevant subset of large sets of information. For instance, approaches herein are able to identify specific observability metrics from large sets that are most indicative of system health and status. Again, this reduces the number of metrics that are evaluated by removing metrics that are not rich datapoints. Approaches herein thereby desirably identify which metrics are informative and which are not. Systems are able to operate more efficiently as a result, because metrics that provide the same or similar information about performance are not processed unnecessarily.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to evaluate new observability metrics and identify rich datapoints therein (e.g., by identifying one or more patterns in the observability metrics). The AI based models may further be incrementally re-trained as observability metrics are received and evaluated over time, thereby providing a dynamic ability to evaluate performance information in real-time and provide an accurate assessment thereof while also maintaining desirable compute throughput. As noted above, this has previously been unachievable due to the intense compute workloads associated with conventional product performance.

Weight values may, in some approaches, be used by the AI reasoning model to collect and analyze information and/or feedback potentially received in response to selecting certain ones of the performance based metrics as opposed to others. Such an AI model ensures that re-training occurs, during which the accuracy of selections made by the AI model(s) is evaluated. In situations where the accuracy of the selections decline, the data used train the AI model(s) may be shifted (e.g., weighted) such that the AI model(s) select more rich and relevant datapoints from the available observability metrics (e.g., performance based information), where the scale of such analysis and determinations would not otherwise be feasible for a human to perform. This is because humans are not able to efficiently perform complex re-training resulting from dynamic evaluation of specific metrics that are identified as being relevant, and would otherwise incorporate processing delays and errors in the process of attempting to do so. Accordingly, management of operations described herein is not able to be achieved by human manual actions.

Moreover, these improvements may be realized in a number of different implementations. For example, approaches herein may be utilized in implementations that involve generating and/or processing alert recommendations. The process of defining a desired (e.g., optimal) set of alerts for a given system is particularly challenging, e.g., due at least in part to the sheer volume of metric data points present in large systems. Alert recommendations have conventionally been curated manually as a result, requiring in-depth subject matter expertise. This often leads to situations where conventional products suffer from insufficient coverage, missing critical events and being unable to dynamically adapt as a system is evolving. In sharp contrast, the approaches herein are able to overcome these shortcomings by selecting relevant (e.g., rich) datapoints for processing, while remaining ones are discarded and ignored.

In another example, approaches herein may be implemented to improve the efficiency by which service level objective (SLO) recommendations may be generated. SLOs are defined around key performance and availability metrics of an application. SLOs thereby offer visibility into the overall state of an application, e.g., providing insights into whether it meets predefined service level expectations. In situations where SLOs are consistently met, this indicates that an application is performing well and maintaining the desired level of service. Thus, selecting a subset of the most informative metrics can help in defining better SLOs. For instance, by focusing on metrics that provide the most valuable insights, more accurate and meaningful SLOs can be created, leading to improved monitoring and management of the performance and health of an application and/or the microservices therein.

In still another example, approaches herein may be implemented to improve the efficiency by which volume management may be performed. Again, metrics which are stationary (e.g., have low entropy) do not offer sufficient insight and can be dropped, allowing for retention and transfer of less data. Approaches herein may also be applied to the use of AIOPs. Once again, the less metric data, the more efficient downstream tasks are able to operate, e.g., such as root cause analysis, anomaly detection, failure prediction, fault classification, etc. This is due at least in part to fact that only quality (e.g., rich) data is fed to the trained model(s), which allows them to perform better. Less data also leads to better mean time to detect and mean time to resolve experienced. Approaches herein may still further be applied in edge locations. As noted above, edge deployments may include thousands of sites and thousands of end devices, producing vast amounts of telemetric data, e.g., in the form of observability metrics. Identifying and selecting only the informative observability metrics in such situations thereby significantly reduces the load on the edge environments.

It should also be noted that, use of the phrase “in a predetermined threshold” is in no way intended to be limiting. Rather than determining whether a value in a predetermined range, equivalent determinations may be made, e.g., as to whether a value is above a predetermined threshold, whether a value is outside a predetermined range, whether an absolute value is above a threshold, whether a value is below a threshold, etc., depending on the desired approach.

Looking now to FIGS. 4A-4G, an in-use example of evaluating various observability metrics in order to select a rich subset thereof for processing, is illustrated in accordance with one approach. In the in-use example, given a set of observability metrics “M”, the objective is to find a subset “S” of the observability metrics that provide rich insight, where S⊆M, such that: maxΣI(m1, m2)∀m1, m2∈S where m1/=m2. Here “I” represents the mutual information between any two observability metrics. Accordingly, an approximation may be made to find a subset of the metrics using a greedy algorithm.

The metrics are quantified by calculating their respective entropy values. The system selects a subset of metrics with higher mutual information for all pairs, correlating to higher measures of uncertainty and/or randomness. The more informative a particular metric is, the more it will contribute towards accurately understanding system health information. This approach includes using this information to continually re-train one or more AI based models for domain expertise.

Moreover, the system selects a subset of metrics by maximizing the aggregate pairwise mutual information. The subset is constructed iteratively with each step quantifying local maximal mutual information between metric pairs. The illustrative pseudocode is depicted in FIG. 4A. The system further selects a subset of metrics by maximizing the aggregate pairwise mutual information conditioned on dynamic runtime behavior of applications with graph-based topology. Micro-service based architecture involves services that perform a specific task and are deployed as separate entities. Data flows from one service to another. In some approaches, this may be implemented as an extension to the mutual information algorithm. The illustrative pseudocode is depicted in FIG. 4B.

Moreover, FIGS. 4C-4G illustrate how the pseudocode in FIGS. 4A-4B are implemented for a given set of application topology information, again which is in no way intended to be limiting. There each node m₁, m₂, m₃, m₄, m₅, m₆, m₇ represents a microservice in a given application. Moreover, the connections extending between certain ones of the nodes correspond to interactions (e.g., communication paths) that extend through the microservices, e.g., as would be appreciated by one skilled in the art after reading the present description.

Looking first to FIG. 4C, none of the nodes in the graphical tree structure have been evaluated. Accordingly, the nodes are each marked as being null. Proceeding to FIG. 4D, the nodes are illustrated following a first iteration of evaluating the graph. For instance, Algorithm 1 shown in FIG. 4A may be implemented in order to determine the desired analysis σₘ₁ (e.g., subset of metrics selected for m₁) of the respective node. Similarly, FIG. 4E illustrates the nodes of the graph following a second iteration of evaluation. There, the desired analysis σₘ₂, σₘ₃ is determined for the respective nodes m₂, m₃. The process of determining the desired analysis σₘ₂, σₘ₃ preferably takes a pivot set into account. In other words, the desired analysis σₘ₂, σₘ₃ of nodes m₂, m₃ preferably incorporates the determined analysis σₘ₁ of node m₁. In other words, each observability metric is preferably evaluated in view of the probabilities that respective paths in the topology information are executed while accounting for dynamic behavior. Algorithm 2 of FIG. 4B may be used to determine the desired analysis of a given node. Accordingly, Probability(path) for node m₂ may be Pr(mₖ), where mx simply corresponds to node m₁.

However, looking to FIG. 4F, the process of determining the desired analysis σₘ₄, σₘ₅ for the respective nodes m₄, m₅ incorporates each of the possible paths thereto. For example, node m₄ has a pivot set determined by σₘ₁Uσₘ₂Uσₘ₃, which translates to a Probability(path) of Pr(m₁, m₂, m₄). However, node m₅ has multiple possible paths. Accordingly, the node m₅ has a pivot set that is also determined by σₘ₁Uσₘ₂Uσₘ₃, which translates to a Probability(path) of Pr(m₁, m₂, m₅), as well as a Probability(path) of Pr(m₁, m₃, m₅).

Looking now to FIG. 4G, each of nodes m₆, m₇ have multiple paths thereto. Accordingly, node m₆ has a pivot set that is determined by σₘ₁Uσₘ₂Uσₘ₃Uσₘ₄Uσₘ₅, which translates to a Probability(path) of Pr(m₁, m₂, m₅, m₆), as well as a Probability(path) of Pr(m₁, m₃, m₅, m₆). Similarly, node m₇ has a pivot set that is also determined by σₘ₁Uσₘ₂Uσₘ₃Uσₘ₄Uσₘ₅, which translates to a Probability(path) of Pr(m₁, m₂, m₅, m₇), as well as a Probability(path) of Pr(m₁, m₃, m₅, m₇).

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving observability metrics associated with a system;
quantifying the observability metrics by determining an entropy value associated with the respective observability metrics;
for a subset of the observability metrics having respective entropy values that are in a first predetermined range, comparing mutual information measures between pairs of the observability metrics in the subset; and
in response to determining differences between the mutual information measures of a given one of the pairs of the observability metrics are outside a second predetermined range:
selecting one of the observability metrics in the given pair to maintain, and
discarding the remaining one of the observability metrics in the given pair.

2. The method of claim 1, further comprising:
in response to determining differences between the mutual information measures of the given pair are not outside the second predetermined range, maintaining both of the observability metrics in the given pair.

3. The method of claim 2, further comprising:
evaluating the maintained observability metrics; and
dynamically developing a real-time understanding of performance health of the system.

4. The method of claim 1, further comprising:
determining whether the observability metrics have respective entropy values that are in the first predetermined range; and
discarding a remainder of the observability metrics having respective entropy values that are not in the first predetermined range.

5. The method of claim 1, wherein the selecting the one of the observability metrics in the given pair to maintain includes:
evaluating application topology information; and
conditioning the selecting on probabilities that respective paths in the topology information are executed while accounting for dynamic behavior.

6. The method of claim 5, wherein the topology information is formed by iteratively quantifying a result of the comparing the mutual information measures between pairs of the observability metrics in the subset.

7. The method of claim 1, wherein the observability metrics include timeseries data outlining performance health of the system.

8. The method of claim 7, wherein the observability metrics are received from various microservices running in an application on the system.

9. A computer program product comprising:
one or more computer-readable storage media; and
program instructions stored on the one or more computer-readable storage media to perform operations comprising:
receiving observability metrics associated with a system;
quantifying the observability metrics by determining an entropy value associated with the respective observability metrics;
for a subset of the observability metrics having respective entropy values that are in a first predetermined range, comparing mutual information measures between pairs of the observability metrics in the subset; and
in response to determining differences between the mutual information measures of a given one of the pairs of the observability metrics are outside a second predetermined range:
selecting one of the observability metrics in the given pair to maintain, and
discarding the remaining one of the observability metrics in the given pair.

10. The computer program product of claim 9, wherein the operations further comprise:
in response to determining differences between the mutual information measures of the given pair are not outside the second predetermined range, maintaining both of the observability metrics in the given pair.

11. The computer program product of claim 10, wherein the operations further comprise:
evaluating the maintained observability metrics; and
dynamically developing a real-time understanding of performance health of the system.

12. The computer program product of claim 9, wherein the operations further comprise:
determining whether the observability metrics have respective entropy values that are in the first predetermined range; and
discarding a remainder of the observability metrics having respective entropy values that are not in the first predetermined range.

13. The computer program product of claim 9, wherein the selecting the one of the observability metrics in the given pair to maintain includes:
evaluating application topology information; and
conditioning the selecting on probabilities that respective paths in the topology information are executed while accounting for dynamic behavior.

14. The computer program product of claim 13, wherein the topology information is formed by iteratively quantifying a result of the comparing the mutual information measures between pairs of the observability metrics in the subset.

15. The computer program product of claim 9, wherein the observability metrics include timeseries data outlining performance health of the system.

16. The computer program product of claim 15, wherein the observability metrics are received from various microservices running in an application on the system.

17. A computer system comprising:
a processor set;
one or more computer-readable storage media; and
program instructions stored on the one or more computer-readable storage media to cause the processor set to perform operations comprising:
receiving observability metrics associated with a system;
quantifying the observability metrics by determining an entropy value associated with the respective observability metrics;
for a subset of the observability metrics having respective entropy values that are in a first predetermined range, comparing mutual information measures between pairs of the observability metrics in the subset; and
in response to determining differences between the mutual information measures of a given one of the pairs of the observability metrics are outside a second predetermined range:
selecting one of the observability metrics in the given pair to maintain, and
discarding the remaining one of the observability metrics in the given pair.

18. The computer system of claim 17, wherein the operations further comprise:
in response to determining differences between the mutual information measures of the given pair are not outside the second predetermined range, maintaining both of the observability metrics in the given pair;
evaluating the maintained observability metrics; and
dynamically developing a real-time understanding of performance health of the system.

19. The computer system of claim 17, wherein the selecting the one of the observability metrics in the given pair to maintain includes:
evaluating application topology information; and
conditioning the selecting on probabilities that respective paths in the topology information are executed while accounting for dynamic behavior.

20. The computer system of claim 19, wherein the topology information is formed by iteratively quantifying a result of the comparing the mutual information measures between pairs of the observability metrics in the subset.
